(19) United States
(12) Patent Application Publication
(10) Pub. No.: US 2023/0385674 A1
(43) Pub. Date: Nov. 30, 2023

(54) ENHANCED CLASSICAL SHADOWS USING MATCHGATE QUANTUM CIRCUITS

(71) Applicant: Google LLC, Mountain View, CA (US)

(72) Inventors: Kianna Wan, Redwood City, CA (US); William Huggins, Oakland, CA (US)

(21) Appl. No.: 18/202,828

(22) Filed: May 26, 2023

Related U.S. Application Data
(60) Provisional application No. 63/346,726, filed on May 27, 2022.

(51) Int. Cl. G06N 10/20; G06N 10/40

(52) U.S. Cl. CPC G06N 10/20; G06N 10/40

(57) ABSTRACT

Methods, systems, and apparatus for enhancing classical shadows using matchgate quantum circuits. In one aspect, a method for computing a classical shadow of an n-qubit quantum state includes repeatedly sampling, by a classical computer, a unitary operator from an ensemble of random unitaries, wherein the ensemble of random unitaries comprises a generalized matchgate group; for each sampled unitary operator: applying, by a quantum computer, a quantum circuit to the n-qubit quantum state to obtain an evolved quantum state, wherein the quantum circuit implements the sampled unitary operator, measuring, by the quantum computer, the evolved quantum state to obtain a respective bit string, and storing, by the classical computer, a record of the respective bit string and the sampled unitary operator; and providing the records as a classical shadow of the quantum state.

### CROSS-REFERENCE TO RELATED APPLICATION

This application claims the benefit of U.S. Provisional Application No. 63/346,726, filed on May 27, 2022, the contents of which are incorporated by reference herein.

BACKGROUND

This disclosure relates to quantum computing.

Shadow tomography is a process that can be used to estimate properties of an unknown quantum state without resorting to full state tomography (which is prohibitively expensive in terms of the number of measurements required). Let ρ denote a quantum state and assume access to multiple copies of the quantum state ρ is possible. Let {Oᵢ} represent a collection of M observables. The task of shadow tomography is to estimate the expectation values Tr(ρOᵢ) up to some additive error ∈ for each operator Oᵢ in the collection of observables. This can be accomplished efficiently by randomly choosing measurement operators from a tomographically complete set.

To specify a protocol, an ensemble of unitaries [symbol] is chosen. Different choices for the ensemble [symbol] are possible. Then, unitaries Uₖ∈ [symbol] are randomly sampled from the ensemble and the state UₖρUₖ^{†} is measured in the computational basis to obtain the basis state |bₖ [symbol] [symbol] bk|. Now, consider the state Uₖ^{†}|bₖ [symbol] [symbol] bk|Uₖ. In expectation, the mapping from ρ to this state defines a quantum channel [symbol] (ρ):= [symbol] ₖ[Uₖ^{†}|bₖ [symbol] [symbol] bk|Uₖ]. It is required that the quantum channel [symbol] be invertible, which is true if and only if the collection of measurement operators defined by drawing the unitaries U∈ [symbol] and measuring in the computational basis is tomographically complete. Assuming that this is true, [symbol] ⁻¹ can be applied to the definition of the quantum channel, yielding ρ= [symbol] ⁻¹( [symbol] ₖ[Uₖ^{†}|bₖ [symbol] [symbol] bk|Uₖ])= [symbol] ₖ[ [symbol] ⁻¹(Uₖ^{†}|bₖ [symbol] [symbol] bk|Uₖ]. The collection { [symbol] ⁻¹(Uₖ^{†}|bₖ [symbol] [symbol] bk|Uₖ)} is the classical shadow of the quantum state ρ.

### SUMMARY

This disclosure describes techniques for enhancing classical shadows using matchgate quantum circuits.

In general, one innovative aspect of the subject matter described in this specification can be implemented in a method for for computing a classical shadow of an n-qubit quantum state, the method comprising: repeatedly sampling, by a classical computer, a unitary operator from an ensemble of random unitaries, wherein the ensemble of random unitaries comprises a generalized matchgate group, and for each sampled unitary operator: applying, by a quantum computer, a quantum circuit to the quantum state p to obtain an evolved quantum state, wherein the quantum circuit that implements the sampled unitary operator, measuring, by the quantum computer and in the computational basis, the evolved quantum state to obtain a respective bit string, and storing, by the classical computer, a record of the respective bit string and the sampled unitary operator; and providing the stored records as a classical shadow of the quantum state.

Other implementations of these aspects includes corresponding computer systems, apparatus, and computer programs recorded on one or more computer storage devices, each configured to perform the actions of the methods. A system of one or more classical and quantum computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations generators of the generalized matchgate group comprise unitary operators that are generated by the action of the operators XⱼXⱼ₊₁, XⱼYⱼ₊₁, YⱼXⱼ₊₁ or YⱼYⱼ₊₁ on an array of n qubits, where 1≤j≤n, Xⱼ represents a Pauli-X operator applied to qubit j, and Yⱼ represents a Pauli-Y operator applied to qubit j; and unitary operators that are generated by the action of Pauli-X operators on qubit n.

In some implementations the generalized matchgate group has a one-to-one correspondence with the group of 2n×2n orthogonal matrices O(2n).

In some implementations for every element R in the group O(2n) there exists a unique unitary operator in the generalized matchgate group that satisfies UγⱼU^{†}=Σ_{j∈[1 . ..2n]}Rₖⱼγₖ.

In some implementations sampling the unitary operator from the ensemble of random unitaries comprises sampling from the group O(2n) according to a Haar measure and constructing a corresponding generalized matchgate unitary operator.

In some implementations the classical shadow is given by

$$\hat{ρ} = \frac{1}{J} {\sum }_{j = 1}^{J} {\sum }_{l = 0}^{n} ( \begin{matrix}2 n \\ 2 l\end{matrix} ) {( \begin{matrix}n \\ l\end{matrix} )}^{- 1} {𝒫}_{2 l} ( {U}_{j}^{†} \vert {b}_{j} 〉 〈 {b}_{j} \vert {U}_{j} )$$

where J represents a number of repetitions performed to sample the unitary operators, Uⱼ represents the unitary operator sampled at repetition j, bⱼ represents the bit string stored at repetition j, and [symbol] ₂ₗ represents a super-operator that projects an input onto a set of Majorana operators with degree 2l, wherein [symbol] ₂ₗ is equivalent to the quantum channel.

In some implementations the method further comprises performing one or more operations using the classical shadow of the quantum state, the operations comprising one or more of: predicting an expectation value of an observable with respect to the quantum state, performing direct fidelity estimation, performing entanglement verification, estimating correlation functions, or predicting entanglement entropy.

In general, another innovative aspect of the subject matter described in this specification can be implemented in a method for computing the expectation value of a projector operator, the method comprising: obtaining a classical shadow of an n-qubit quantum state, wherein the classical shadow comprises a quantum channel of unitary operators sampled from an ensemble of random unitaries and measured bit strings; generating updated unitary operators, comprising multiplying a unitary operator that defines the projector operator with i) the unitary operators sampled from the ensemble of random unitaries and ii) operators that prepare the measured bit strings from a vacuum state; and computing the expectation value of the quantum channel with respect to the vacuum state, the computing comprising evaluating derivatives of a polynomial, the polynomial comprising a Pfaffian of a matrix comprising the updated unitary operators.

Other implementations of these aspects includes corresponding computer systems, apparatus, and computer programs recorded on one or more computer storage devices, each configured to perform the actions of the methods. A system of one or more classical computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the projection operator comprises an operator that projects a quantum state onto a pure fermionic Gaussian state.

In some implementations the pure fermionic Gaussian state comprises a unitary operator in the ensemble of random unitaries applied to a vacuum state.

In some implementations the projector operator is given by |ϕ [symbol] [symbol] ϕ|=Ũ|0 [symbol] [symbol] 0|Ũ^{†} where |0 [symbol] represents the vacuum state and Ũ is the unitary operator that defines the projector operator, wherein Ũ is in the ensemble of random unitaries.

In some implementations the ensemble of random unitaries comprises a generalized matchgate group.

In some implementations the classical shadow is given by

$$\hat{ρ} = \frac{1}{J} {\sum }_{j = 1}^{J} {\sum }_{l = 0}^{n} ( \begin{matrix}2 n \\ 2 l\end{matrix} ) {( \begin{matrix}n \\ l\end{matrix} )}^{- 1} {𝒫}_{2 l} ( {U}_{j}^{†} \vert {b}_{j} 〉 〈 {b}_{j} \vert {U}_{j} )$$

where J represents a number of repetitions performed to sample the unitary operators, Uⱼ represents the unitary operator sampled at repetition j, bⱼ represents the bit string stored at repetition j, and [symbol] ₂ₗ represents a super-operator that projects an input onto a set of Majorana operators with degree 2l, wherein [symbol] ₂ₗ is equivalent to the quantum channel.

In some implementations generating the updated unitary operators comprises redefining the unitary operators Uⱼ to absorb the unitary operator Ũ and the preparation of |bⱼ [symbol] from |0 [symbol] .

In some implementations computing the expectation value of the quantum channel with respect to the vacuum state comprises computing the expectation value of the super-operator with respect to the vacuum state, wherein the super-operator projects the updated unitary operators applied to the vacuum state onto a set of Majorana operators with degree 2l.

In some implementations computing the expectation value of the super-operator with respect to the vacuum state comprises computing tr[|0 [symbol] [symbol] 0| [symbol] ₂ₗ(U⁵⁵⁴ |0 [symbol] [symbol] 0|U)].

In some implementations the matrix that comprises the updated unitary operators is given by

$${M}_{0} + z Q {M}_{0} {Q}^{T} where {M}_{0} = {[ \begin{matrix}0 & 1 \\ - 1 & 0\end{matrix} ]}^{⊗ n} ,$$

z is the argument of the polynomial, and Q represents an element of SO(2n) that corresponds to the updated unitary operator.

In some implementations evaluating the derivatives of the polynomial comprises performing numerical differentiation or polynomial interpolation techniques.

In general, another innovative aspect of the subject matter described in this specification can be implemented in a method for computing the expectation value of an operator, the method comprising: obtaining a classical shadow of an n-qubit quantum state, wherein the classical shadow comprises a quantum channel of unitary operators sampled from an ensemble of random unitaries and measured bit strings; generating updated unitary operators, comprising multiplying a unitary operator that defines the operator with the unitary operators sampled from the ensemble of random unitaries; and computing the expectation value of the quantum channel with respect to an outer product of computational basis states included in the operator and the vacuum state, the computing comprising evaluating derivatives of a polynomial, the polynomial comprising a Pfaffian of a matrix comprising the updated unitary operators.

Other implementations of these aspects includes corresponding computer systems, apparatus, and computer programs recorded on one or more computer storage devices, each configured to perform the actions of the methods. A system of one or more classical computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations the operator comprises a slater determinant and a vacuum state.

In some implementations the slater determinant comprises a unitary operator in the ensemble of random unitaries that conserves an excitation number applied to a computational basis state with the excitation number.

In some implementations the operator is given by |ϕ [symbol] [symbol] 0|=U_{ϕ}|x [symbol] [symbol] 0|U_{ϕ}^{†} where |0 [symbol] represents the vacuum state, U_{ϕ} is the unitary operator that defines the operator, wherein U_{ϕ} is in the ensemble of random unitaries, and |x [symbol] represents the computation basis state.

In some implementations the ensemble of random unitaries comprises a generalized matchgate group.

In some implementations the classical shadow is given by

$$\hat{ρ} = \frac{1}{J} {\sum }_{j = 1}^{J} {\sum }_{l = 0}^{n} ( \begin{matrix}2 n \\ 2 l\end{matrix} ) {( \begin{matrix}n \\ l\end{matrix} )}^{- 1} {𝒫}_{2 l} ( {U}_{j}^{†} \vert {b}_{j} 〉 〈 {b}_{j} \vert {U}_{j} )$$

where J represents a number of repetitions performed to sample the unitary operators, Uⱼ represents the unitary operator sampled at repetition j, bⱼ represents the bit string stored at repetition j, and [symbol] ₂ₗ represents a super-operator that projects an input onto a set of Majorana operators with degree 2l, wherein [symbol] ₂ₗ is equivalent to the quantum channel.

In some implementations generating the updated unitary operators comprises redefining the unitary operators Uⱼ to absorb the unitary operator U_{ϕ}.

In some implementations computing the expectation value of the quantum channel with respect to the outer product of computational basis states included in the operator and the vacuum state comprises computing the expectation value of the super-operator with respect to the outer product of computational basis states included in the operator and the vacuum state, wherein the super-operator projects the updated unitary operators applied to the bit strings onto a set of Majorana operators with degree 2l.

In some implementations computing the expectation value of the super-operator with respect to the outer product of computational basis states included in the operator and the vacuum state comprises computing tr[|x [symbol] [symbol] 0| [symbol] ₂ₗ(U^{†}|b [symbol] [symbol] b|U)].

In some implementations the matrix that comprises the updated unitary operators is given by

$$( {M}_{x} + z {V}_{x}^{*} Q {M}_{b} {Q}^{T} {V}_{x}^{†} ) [ S ] where for x ∈ \{ 0 , 1 \} , {M}_{x} := {⊕}_{j ∈ [ n ]} ( \begin{matrix}0 & {( - 1 )}^{{x}_{j}} \\ - {( - 1 )}^{{x}_{j}} & 0\end{matrix} ) ,$$

z is the argument of the polynomial, Q represents an element of O(2n) that corresponds to the updated unitary operator,

$${V}_{x} = {⊕}_{j = 1}^{n} {v}_{{x}_{j}} with {v}_{0} = ( \begin{matrix}1 & 0 \\ 0 & 1\end{matrix} ) , {v}_{1} = \frac{1}{\sqrt{2}} ( \begin{matrix}1 & - i \\ 1 & i\end{matrix} ) , {S}_{x} = [ 2 n ] \{ 2 j - 1 : {x}_{j} = 1 \}$$

and M[S] represents the restriction of matrix S to rows and columns with indices in S.

In some implementations evaluating the derivatives of the polynomial comprises performing numerical differentiation or polynomial interpolation techniques.

The subject matter described in this specification can be implemented in particular embodiments so as to realize one or more of the following advantages.

Systems implementing the presently described techniques use a new ensemble of unitaries in the classical shadow framework—a generalized matchgate group. Using this continuous family of unitaries provides several technical advantages when using shadow tomography, particularly on noisy quantum computing devices. For example, it is often difficult to precisely implement particular gates. A protocol built on continuous rotations rather than discrete rotations can therefore be particular advantageous, since such protocols can be less sensitive to over- and under-rotation errors due to averaging over a continuous family of rotations, particularly if the errors can be fully or partially characterized (where in this context “averaging” refers to the fact that random unitaries are sampled and the estimate of the expectation value is averaged over the different samples, which occurs when post-processing the data to extract one or more expectation values.)

In addition, the presently described techniques can be used in the context of analog quantum simulation, where it may be practical to implement evolution by random generalized matchgate unitaries by making use of their correspondence to free-fermion evolution. This can enable the use of shadow tomography in analog simulators based on neutral atoms or ion traps. In an analog simulator only coarse-grained control over the system may be possible. In particular, it might be very difficult to implement specific gates. However, the presently described techniques do not require specific gates, only the implementation of random gates drawn from a specific family of gates. In other words, the random matchgates are generated by the evolution under randomly distributed free fermion Hamiltonians (with a suitable distribution). This can be used in an analog simulator where there is sufficient control to evolve under a random free fermion Hamiltonian but not enough control to precisely implement particular gates.

In addition, calculating the fidelity of an experimentally prepared state with some target state is a standard experimental task. Using previously known approaches, an exponential amount of classical post-processing is required to estimate the expectation value of an operator, e.g., a projector onto an arbitrary fermionic Gaussian state, using a classical shadow. The presently described techniques reduces the amount of classical post-processing required to evaluate these expectations values. In particular, the amount of classical post-processing scales cubically with system size when a classical shadow based on random matchgates is used. Furthermore, numerical experiments confirm that the sample efficiency of the presently described techniques (e.g., the number of physical measurements required) is also improved and scales efficiently with system size.

Further, the ability to efficiently evaluate the expectation value of projectors (fidelities) with matchgate classical shadows opens up new possibilities for benchmarking device and algorithm performance. This is especially true in the domain of quantum simulation for chemistry and material science where fermionic Gaussian states play a central role. For example, the presently described classical shadow technique enables the efficient evaluation of the fidelity of the physically prepared state with an arbitrary fermionic Gaussian state. If a circuit that should (in the absence of noise) have a certain fidelity with a fermionic Gaussian state is executed then this can be verified using the presently described classical shadow techniques. In addition, oftentimes the states that are relevant to quantum simulation have support on a small number of fermionic Gaussian states, and the presently described techniques can provide an effective way to verify the execution of some medium-sized circuits.

In addition, the presently described techniques further enlarge the set of operators that can be efficiently estimated using shadow tomography. As with the evaluation of projectors onto fermionic Gaussian states, the techniques for the evaluation of the matrix elements described herein will be useful for benchmarking quantum computers and quantum algorithms. Generalizations of the exact techniques presented also enable the computation of other off-diagonal matrix elements. This, in turn, allows for the efficient evaluation of fidelities with wavefunctions that are a superposition of (polynomially many) Gaussian states.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for enhancing classical shadows using matchgate quantum circuits.

FIG. 2 is a flow diagram of a process for computing a classical shadow of an n-qubit quantum state.

FIG. 3 is a flow diagram of an example process for computing the expectation value of a projector operator that projects a quantum state onto a pure fermionic Gaussian state.

FIG. 4 is a flow diagram of an example process for computing the expectation value of an operator.

FIG. 5 shows two example plots that illustrate the sampling efficiency of the presently described techniques.

FIG. 6 depicts an example classical/quantum computer.

### DESCRIPTION

This specification describes techniques for computing classical shadows and using the classical shadows to evaluate expressions, e.g., expectation values. The classical shadows are computed using a new ensemble of unitaries—a generalized matchgate group. The quantum channel that results from this new ensemble of unitaries invertible. Further, the classical post-processing required to use the resulting quantum channel is efficient. In particular, classical shadows generated using the presently described quantum channel can be used to evaluate expectation values at a cost that scales cubically in the number of qubits. This provides a technical improvement over the state of the art, where current techniques evaluate expectation values at a cost that scales exponentially in the number of qubits.

In the present disclosure, the term “ensemble” is understood to refer to a set (for example, the set of matchgate unitaries) together with a probability distribution (for example, distributed according to the Haar measure). A “sample from the ensemble” is implied to be drawn randomly from the set according to the distribution.

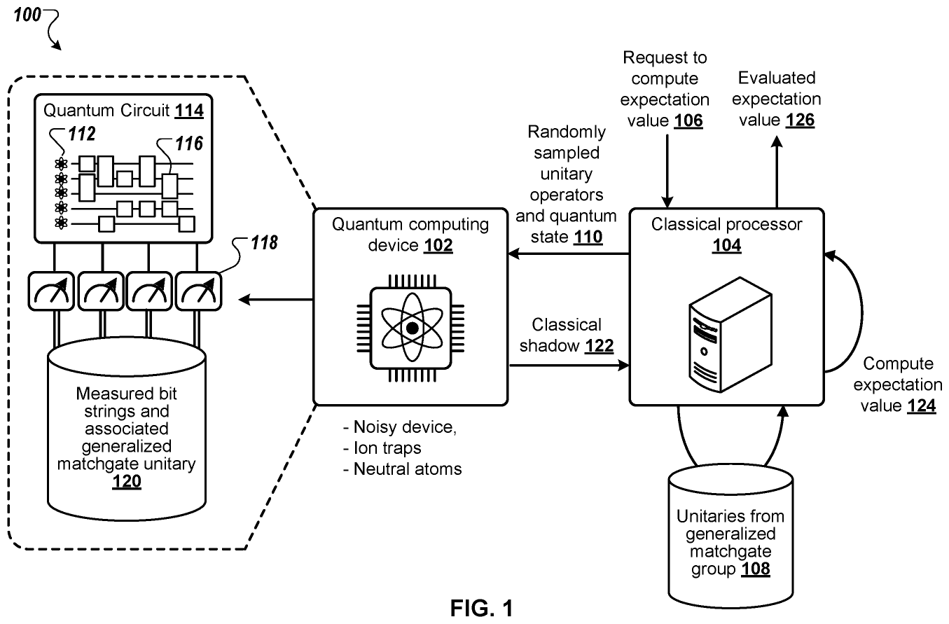

FIG. 1 is a block diagram of an example system 100 for enhancing classical shadows using matchgate quantum circuits. The example system 100 is an example of a system implemented as classical and quantum computer programs on one or more classical computers and quantum computing devices in one or more locations, in which the systems, components, and techniques described herein can be implemented.

The example system 100 includes a quantum computing device 102 in data communication with a classical processor 104. For illustrative purposes, the quantum computing device 102 and classical processor 104 shown in FIG. 1 are illustrated as separate entities, however in some implementations the classical processor 104 may be included in quantum computing device 102. For example, in some implementations the quantum computing device 102 can be directly connected to the classical processor 104. In other implementations, the quantum computing device 102 can be connected to the classical processor 104 through a network, e.g., a local area network (LAN), wide area network (WAN), the Internet, or a combination thereof.

The classical processor 104 includes components for performing classical computation and can be implemented as one or more computer programs, i.e., one or more modules of computer program instructions encoded on a tangible non-transitory storage medium for execution by, or to control the operation of, a data processing apparatus. The computer storage medium can be a machine-readable storage device, a machine-readable storage substrate, a random or serial access memory device, or a combination of one or more of them.

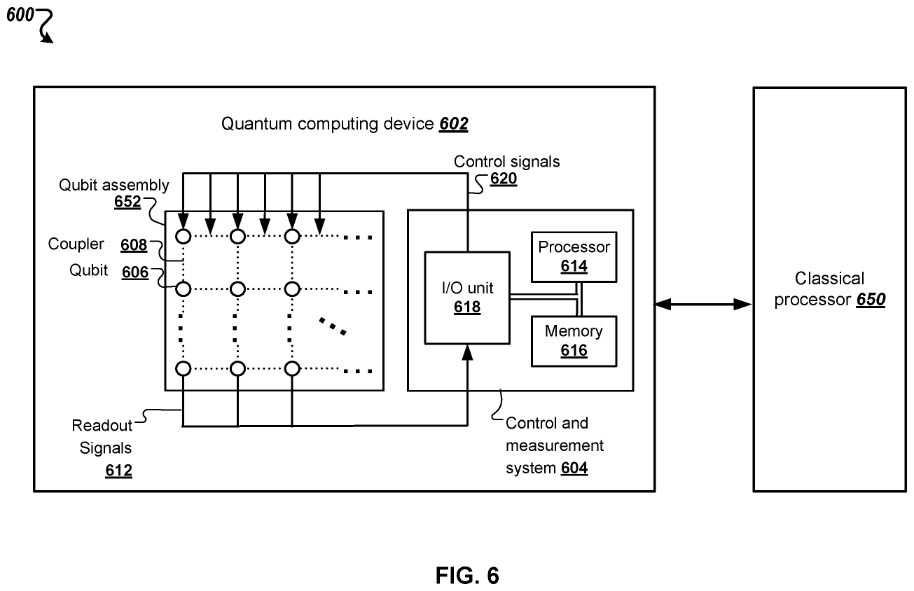

The quantum computing device 102 includes components for performing quantum computation. For example, the quantum computing device 102 can include a qubit array, quantum circuitry, and control devices configured to operate physical qubits in the qubit array and apply quantum circuits to the qubits. In some implementations the quantum computing device 102 can be a noisy device, e.g., a noisy intermediate-scale quantum device (NISQ device), a trapped ion quantum computer, or a neutral atom quantum computer. An example quantum computing device is described in the more detail below with reference to FIG. 6.

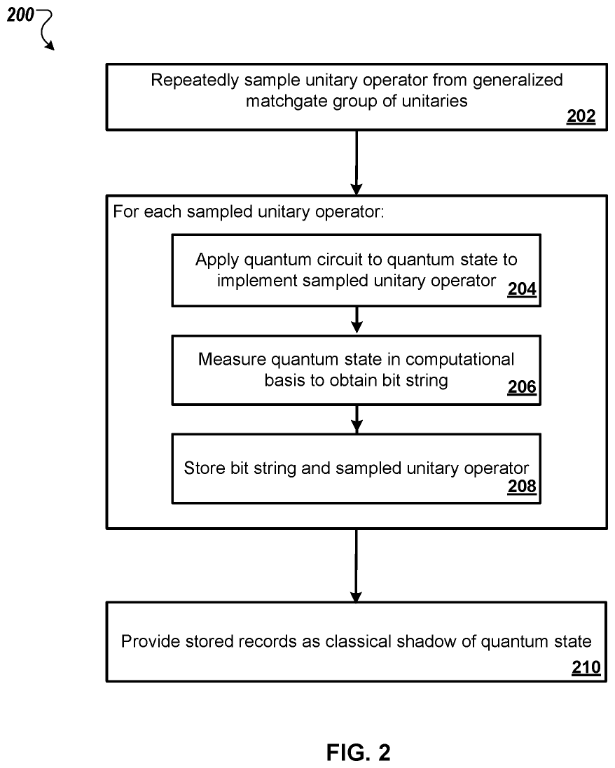

The classical processor 104 is configured to receive a request 106 to evaluate an expectation value of an operator, e.g., a projector operator or matrix elements between slater determinants and the vacuum state, with respect to a quantum state. The classical processor 104 is then configured to use the quantum computing device χto perform shadow tomography and compute a classical shadow of the quantum state. The classical processor 104 repeatedly randomly samples a unitary operator from an ensemble of unitary operators. The ensemble of unitary operators includes unitary operators from a generalized matchgate group 108, as described in more detail below with reference to example process 200 of FIG. 2.

The classical processor 104 is configured to provide data 110 representing the randomly sampled unitary operators and the quantum state specified in the request 106 to the quantum computing device 102. For each randomly sampled unitary operator, the quantum computing device 102 is configured to prepare an array of physical qubits 112 in the quantum state and apply a quantum circuit 114 to the quantum state. Application of the quantum circuit evolves the quantum state under the randomly sampled unitary operator. The quantum computing device 102 is then configured to measure 118 the evolved quantum state in the computational basis to obtain a respective bit string.

In the example shown in FIG. 1, the quantum computing device 102 is configured to store a record of each measured bit string and the randomly sampled unitary operator to which the measured bit string corresponds to in storage 120. After the quantum computing device 102 has obtained one or more bit strings for each of the randomly sampled unitary operators 110, the quantum computing device 102 is configured to provide the stored records 120 to the classical processor 104 as a classical shadow 122 of the quantum state. In other implementations, the classical processor 104 can be configured to store records of each bit string measured by the quantum computing device 102. Example operations performed by the quantum computing device 102 and classical processor 104 to compute a classical shadow of a quantum state using generalized matchgates are described in more detail below with reference to FIG. 2.

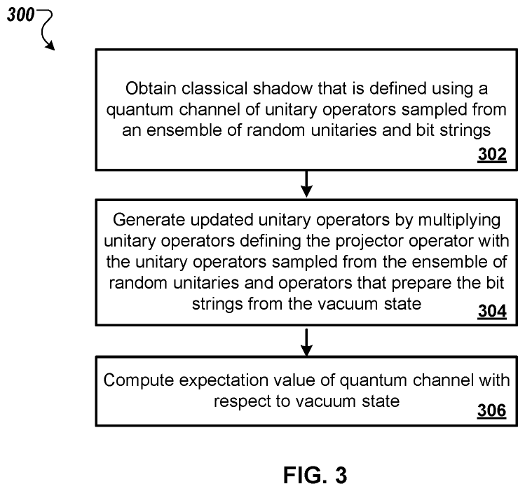

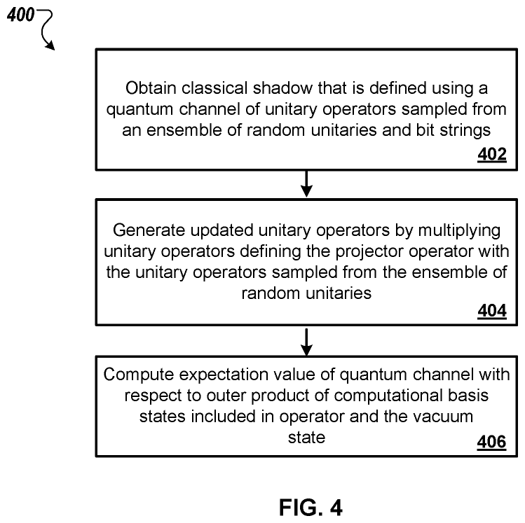

The classical processor 104 is configured to use the classical shadow 122 of the quantum state to evaluate 124 the requested expectation value of the operator with respect to the quantum state and provide the evaluated expectation value 126 as output. Because of the particular structure of the classical shadow 122, the classical processor 104 can efficiently evaluate this expectation value, e.g., a cost that scales at most cubically in the number of qubits used by the quantum computing device 102 to compute the classical shadow. Example operations performed by the classical processor 104 to evaluate an expectation value of an operator with respect to a quantum state are described in more detail below with reference to FIGS. 3 and 4.

FIG. 2 is a flow diagram of a process 200 for computing a classical shadow of an n-qubit quantum state. For convenience, the process 200 will be described as being performed by a system of one or more classical and quantum computing devices located in one or more locations. For example, the system 100 of FIG. 1, appropriately programmed, can perform example process 200.

The system repeatedly samples, by a classical processor, a unitary operator from an ensemble of random unitaries (step 202). The ensemble of random unitaries is a generalized matchgate group, where each unitary operator in the ensemble of unitary operators generates a respective generalized matchgate quantum circuit. A generalized matchgate quantum circuit is a quantum circuit that can be applied to n qubits with nearest neighbor interactions, e.g., a one-dimensional chain of n qubits, where the quantum circuit includes two qubit gates that implement the rotation e^{-iθXX} for some angle θ (e.g., quantum gates generated by the operator X⊗X) where X represents a Pauli-X matrix. An example two qubit gate that implements the rotation

$${e}^{- \frac{i θ}{2} X X}$$

is given below in matrix form:

$${R}_{XX} ( θ ) = exp ( - 1 \frac{θ}{2} X ⊗ X ) = ( \begin{matrix}cos ( \frac{θ}{2} ) & 0 & 0 & - i sin ( \frac{θ}{2} ) \\ 0 & cos ( \frac{θ}{2} ) & - i sin ( \frac{θ}{2} ) & 0 \\ 0 & - i sin ( \frac{θ}{2} ) & cos ( \frac{θ}{2} ) & 0 \\ - i sin ( \frac{θ}{2} ) & 0 & 0 & cos ( \frac{θ}{2} )\end{matrix} )$$

The quantum circuit also includes a single qubit X gate on the last qubit in the line of qubits and, optionally, one or more single qubit Z(θ) quantum gates. In some implementations the single qubit X gate can also be parameterized, e.g., dependent on θ.

In other words, generators of the generalized matchgate group include unitary operators that are generated by the action of the operators XⱼXⱼ₊₁, XⱼYⱼ₊₁, YⱼXⱼ₊₁ or YⱼYⱼ₊₁ on an array of n qubits, where 1≤j≤n, Xⱼ represents a Pauli-X operator applied to qubit j, and Yⱼ represents a Pauli-Y operator applied to qubit j and unitary operators that are generated by the action of Pauli-X operators on qubit n.

In some implementations, a matchgate is defined as a class of two-qubit gates, generated by two-qubit X rotations of the form exp(iθX⊗X) and single qubit Z rotations exp(iθZ⊗I) and exp(iθI⊗Z). Matchgate circuits can be defined as the unitaries generated by nearest-neighbour matchgates (e.g. where the n qubits are placed on a 1D chain) along with the Pauli X operator Xₙ on the last qubit of the 1D chain. Another way of viewing such matchgate circuits is as qubit representations of fermionic Gaussian unitaries under the Jordan-Wigner transformation, where a Gaussian unitary is a unitary operator that transforms between valid sets of Majorana operators (i.e. is equivalent to applying a matrix Q∈O(2n) to a set of 2n Majorana operators).

In some implementations, the system can randomly sample the unitary operator from the ensemble of random unitaries by sampling from the group O(2n) according to a Haar measure. The generalized matchgate group has a one-to-one correspondence with the group of 2n×2n orthogonal matrices O(2n). For every element R in the group O(2n), there exists a unique unitary operator in the generalized matchgate group that satisfies UγⱼU^{†}=Σ_{j∈[1 . ..2n]}Rₖⱼγₖ. Therefore, the system can sample a random unitary operator from the the group O(2n) and construct a corresponding generalized matchgate unitary operator from the sampled unitary operator using the above described one-to-one correspondence.

For each unitary operator randomly sampled at step 202, the system uses a quantum computing device to prepare the n-qubit quantum state and apply a quantum circuit to the quantum state to obtain an evolved quantum state (step 204). Application of the quantum circuit to the n-qubit quantum state implements evolution of the n-qubit quantum state under the sampled unitary operator. That is, the quantum circuit is a matchgate quantum circuit that is generated by the unitary operator. The system then measures the evolved quantum state, e.g., in the computational basis, to obtain a respective bit string (step 204). The system stores a record of the bit string and the randomly unitary operator used to generate the bit string (step 208).

After the system has performed steps 204-208 one or more times for each randomly sampled unitary operator, the system provides the stored records as a classical shadow of the quantum state (step 210). The classical shadow is, for example, given by Eq. (1) below.

$$\hat{ρ} = \frac{1}{J} {{\sum }^{J}}_{j = 1} {{\sum }^{n}}_{l = 0} ( \begin{matrix}2 n \\ 2 l\end{matrix} ) {( \begin{matrix}n \\ l\end{matrix} )}^{- 1} {𝒫}_{2 l} ( {U}_{j}^{†} \vert {b}_{j} 〉 〈 {b}_{j} \vert {U}_{j} ) \qquad ( 1 )$$

In Eq. (1), J represents the number of unitary operators sampled at step 202, Uⱼ represents the unitary operator sampled at repetition j, bⱼ represents the bit string stored at repetition j, and [symbol] ₂ₗ represents a super-operator that projects an input onto a set of Majorana operators with degree 2l.

In some implementations the system can perform one or more operations using the classical shadow of the quantum state. For example, the system can use the classical shadow to predict an expectation value of an operator with respect to the quantum state, as described below with reference to FIGS. 2 and 3. Alternatively, the system can use or provide the classical shadow for use in subsequent computations, e.g., to perform direct fidelity estimation, entanglement verification, correlation function estimation, or entanglement entropy prediction.

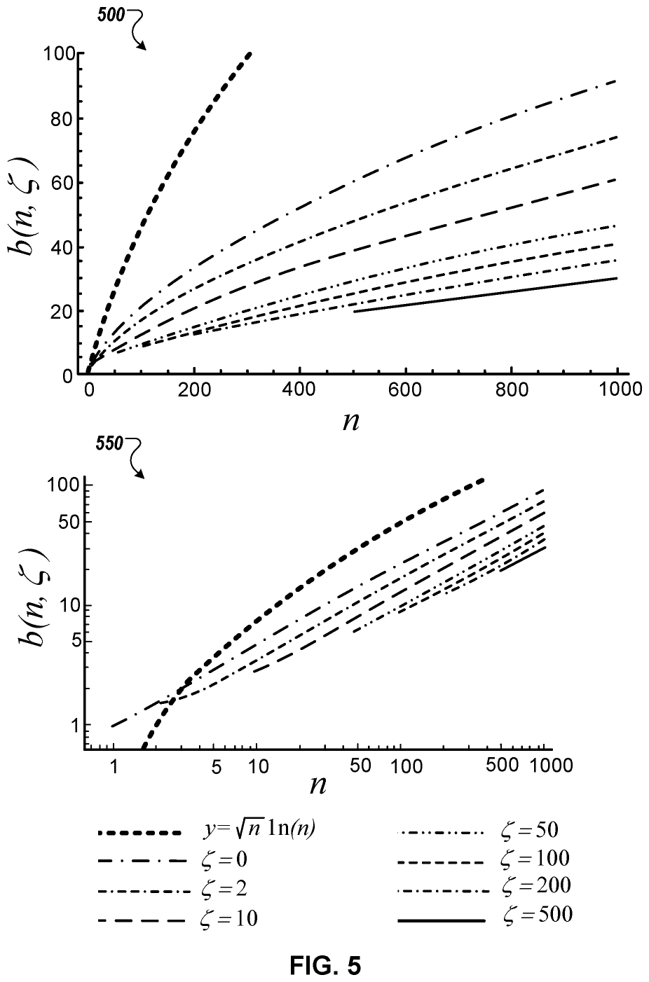

It has been confirmed with numerical experiments that the sampling efficiency of example process 200, e.g., the number of physical measurements required to compute a classical shadow, scales efficiently with system size n (as shown in FIG. 5).

FIG. 3 is a flow diagram of an example process 300 for computing the expectation value of a projector operator. The projector operator can be an operator that projects a quantum state ρ onto a pure fermionic Gaussian state |ϕ [symbol] . A quantum state is a pure fermionic Gaussian state if it can be generated through application of a unitary operator in a generalized matchgate group to a vacuum state, e.g., |ϕ [symbol] =U|0 [symbol] where U is a unitary operator in the generalized matchgate group and |0 [symbol] represents the vacuum state (which is a state with zero particles, mapped to an all-zero qubit state, e.g., under the Jordan-Wigner transformation). That is, the projector operator can be given by |ϕ [symbol] [symbol] ϕ|=U|0 [symbol] [symbol] 0|U^{†}. For convenience, the process 300 will be described as being performed by a system of one or more classical and quantum computing devices located in one or more locations. For example, the system 100 of FIG. 1, appropriately programmed, can perform example process 300.

The system obtains a classical shadow of an n-qubit quantum state (step 302). The classical shadow is a classical shadow generated using a quantum channel of unitary operators sampled from an ensemble of random unitaries and measured bit strings. The classical shadow can be prepared using the techniques described above with reference to example process 200 of FIG. 2. For example, the ensemble of random unitaries can be the generalized matchgate group.

The system generates updated unitary operators by multiplying the unitary operator that defines the projector operator with i) the unitary operators sampled from the ensemble of random unitaries and ii) operators that prepare the measured bit strings from a vacuum state (step 304). That is, the system redefines the unitary operator U to absorb the unitary operator Ũ and the preparation of |bⱼ [symbol] from |0 [symbol] as follows.

To efficiently evaluate the expectation value tr(|ϕ [symbol] [symbol] ϕ|\hat{ρ}), where |ϕ [symbol] [symbol] ϕ|=Ũ|0 [symbol] [symbol] 0|Ũ^{†}. represents the projector operator and p represents the classical shadow of the quantum state p, e.g., as defined in Eq. (1) above, it is sufficient to evaluate the expression given by Eq. (2) below

tr(|ϕ [symbol] [symbol] ϕ| [symbol] ₂ₗ(U^{†}|b [symbol] [symbol] b|U))=tr(Ũ|0 [symbol] [symbol] 0|Ũ^{†} [symbol] ₂ₗ(U^{†}|b [symbol] [symbol] b|U)) (2)

for arbitrary integers l∈[0, . . . , n], unitary operators U in the generalized matchgate group for n-qubits [symbol] ₙ⁺, and computational basis states |b). Because elements of the generalized matchgate group for n-qubits [symbol] ₙ⁺ commute with the super-operator [symbol] ₂ₗ, the unitary operators Ũ that define the projector operator can be acted onto (U^{†}|b [symbol] [symbol] b|U) to redefine the unitary operators U to absorb the unitary operators Ũ, as well as the preparation of the computational basis states |b [symbol] from the vacuum state.

The system then uses the redefined unitary operators to evaluate the expectation value of the projector operator with respect to the classical shadow of the quantum state (step 306). In particular, the system evaluates the expectation value of the quantum channel with respect to the vacuum state. That is, the system evaluates the quantity given by Eq. (3) below,

tr(|0 [symbol] [symbol] 0| [symbol] ₂ₗ(U^{†}|0 [symbol] [symbol] 0|U)) (3)

where U now represents the redefined unitary operators. It can be shown that the expression given by Eq. (3) above is equal to

$$tr ( \vert 0 〉 〈 0 \vert {𝒫}_{2 l} ( {U}^{†} \vert 0 〉 〈 0 \vert U ) ) = \frac{1}{l !} \frac{{d}^{l}}{d {z}^{l}} p ( z ) {\vert}_{z = 0} \qquad ( 4 )$$

where

$$p ( z ) = \frac{1}{{2}^{n}} P f ( {M}_{0} + z Q {M}_{0} {Q}^{T} )$$

is a polynomial where Pf represents the Pfaffian of a matrix, Q is an element of the special orthogonal group SO(2n) that corresponds to the updated unitary operator U, and M₀ is a matrix given by

$${M}_{0} = {[ \begin{matrix}0 & 1 \\ - 1 & 0\end{matrix} ]}^{⊗ n} .$$

Therefore, to evaluate the expectation value of the projector operator with respect to the classical shadow of the quantum state, the system can compute derivatives of a polynomial that includes a Pfaffian of a matrix that, in turn, includes the updated unitary operators.

The system can calculate the Pfaffian of the matrix M₀+zQM₀Q^{T} for specific values of z at a cost that scales at most cubically in n using standard methods, e.g., numerical differentiation or polynomial interpolation techniques. Therefore, because of the structure of the classical shadow obtained at step 302, the system implementing example process 300 is only required to perform a number of physical measurements that scales with system size n (as described above with reference to example process 200 of FIG. 2) and an amount of classical post-processing that scales cubically in n.

FIG. 4 is a flow diagram of an example process 400 for computing the expectation value of an operator. The operator can be an outer product of a slater determinant |ϕ [symbol] and a vacuum state |0 [symbol] (which is a state with zero particles, mapped to an all-zero qubit state, e.g., under the Jordan-Wigner transformation). The slater determinant |ϕ [symbol] can be generated through application of a unitary operator U_{ϕ} in a generalized matchgate group that conserves an excitation number (and acts as the identify on the vacuum state |0 [symbol] to a computational basis state |x [symbol] with the excitation number, e.g., |ϕ [symbol] =U_{ϕ}|x [symbol] . For example, the operator can be given by |ϕ [symbol] [symbol] 0|=U_{ϕ}|x [symbol] [symbol] 0|U_{ϕ}^{†}. For convenience, the process 400 will be described as being performed by a system of one or more classical and quantum computing devices located in one or more locations. For example, the system 100 of FIG. 1, appropriately programmed, can perform example process 400.

The system obtains a classical shadow of an n-qubit quantum state (step 402). The classical shadow is a classical shadow generated using a quantum channel of unitary operators sampled from an ensemble of random unitaries and measured bit strings. The classical shadow can be prepared using the techniques described above with reference to example process 200 of FIG. 2. For example, the ensemble of random unitaries can be the generalized matchgate group.

The system generates updated unitary operators by multiplying the unitary operator that defines the operator with the unitary operators sampled from the ensemble of random unitaries (step 304). That is, the system redefines the unitary operator U to absorb the absorb the unitary operator U_{ϕ}, as follows.

To efficiently evaluate the expectation value tr(|ϕ [symbol] [symbol] 0|\hat{ρ}, where |ϕ [symbol] =U_{ϕ}|x [symbol] represents the Slater determinant, |0 [symbol] represents the vacuum state, and \hat{ρ} represents the classical shadow of the quantum state ρ, e.g., as defined in Eq. (1) above, it is sufficient to evaluate the expression given in Eq. (5) below

tr(|ϕ [symbol] [symbol] 0| [symbol] ₂ₗ(U^{†}|b [symbol] [symbol] b|U))=tr(U_{ϕ}x [symbol] [symbol] 0|U_{ϕ}^{†} [symbol] ₂ₗ(U^{†}|b [symbol] [symbol] b|U)) (5)

for arbitrary integers l∈[0, . . . n], unitary operators U in the generalized matchgate group for n-qubits [symbol] ₙ⁺, and computational basis states |b [symbol] . Because elements of the generalized matchgate group for n-qubits [symbol] ₙ⁺ commute with the super-operator [symbol] ₂ₗ, the unitary operators U_{ϕ} that define the Slater determinant can be acted onto (U^{†}|b [symbol] [symbol] b|U) to redefine the unitary operators U to absorb the unitary operators U_{ϕ}.

The system then uses the redefined unitary operators to evaluate the expectation value of the operator with respect to the classical shadow of the quantum state (step 406). In particular, the system evaluates the expectation value of the quantum channel with respect to an outer product of computational basis states included in the operator and the vacuum state. That is, the system evaluates the quantity given by Eq. (6) below,

tr(|x [symbol] [symbol] 0| [symbol] ₂ₗ(U^{†}|b [symbol] [symbol] b|U)) (6)

where U now represents the redefined unitary operators. It can be shown that the expression given by Eq. (6) above is equal to

$$tr ( \vert 0 〉 〈 0 \vert {𝒫}_{2 l} ( {U}^{†} \vert b 〉 〈 b \vert U ) ) = \frac{1}{l !} \frac{{d}^{l}}{d {z}^{l}} {q}_{x , b} ( z ) {\vert}_{z = 0} \qquad ( 7 )$$

where

$${q}_{x , b} ( z ) = \frac{1}{{2}^{n - \frac{η}{2}}} {i}^{\frac{η}{2}} Pf ( ( {M}_{x} + z {V}_{x}^{*} Q {M}_{b} {Q}^{T} {V}_{x}^{†} ) [ S \} )$$

is a polynomial where Pf represents the Pfaffian of a matrix, Q is an element of the special orthogonal group SO(2n) that corresponds to the updated unitary operator U, M[S] represents the restriction of the matrix S to rows and columns with indices in S, and for x∈{0,1}ⁿ,

$${M}_{x} := {⊕}_{j ∈ [ n ]} ( \begin{matrix}0 & {( - 1 )}^{{x}_{j}} \\ - {( - 1 )}^{{x}_{j}} & 0\end{matrix} ) , {V}_{x} := {⊕}_{j = 1}^{n} {v}_{{x}_{j}} with {v}_{0} = ( \begin{matrix}1 & 0 \\ 0 & 1\end{matrix} ) , {v}_{1} = \frac{1}{\sqrt{2}} ( \begin{matrix}1 & - i \\ 1 & i\end{matrix} ) , {S}_{x} = [ 2 n ] \{ 2 j - 1 : {x}_{j} = 1 \} .$$

Therefore, to evaluate the expectation value of the operator with respect to the classical shadow of the quantum state, the system can compute derivatives of a polynomial, the polynomial including a Pfaffian of a matrix which, in turn, includes the updated unitary operators.

The system can calculate the Pfaffian of the matrix for specific values of z at a cost that scales at most cubically in n using standard methods, e.g., numerical differentiation or polynomial interpolation techniques. Therefore, because of the structure of the classical shadow obtained at step 402, the system implementing example process 400 is only required to perform a number of physical measurements that scales with system size n (as described above with reference to example process 200 of FIG. 2) and an amount of classical post-processing that scales cubically in n.

FIG. 5 shows two example plots that illustrate the sampling efficiency of the presently described techniques. In particular, FIG. 5 includes linear and log-log plots 500, 550 of b(n, ζ) (the bound on the variance for estimating the expectation value of |ϕ [symbol] [symbol] 0| using the presently described matchgate classical shadows, where |ϕ [symbol] is any n-mode, ζ-fermion Slater determinant) vs. n, for ζ∈{0, 2, 10, 50, 100, 200, 500} (evaluated at integer values of n and joined). The quantity y=√n ln(n) is also plotted for comparison. As described herein, estimating the expectation value allows for the estimation of the overlap between any pure state and |ϕ [symbol] . The quantity b(n, 0) is also equal to the variance bound for estimating the expectation values of arbitrary Gaussian density operators.

As shown, the variance is calculated for various parameters and in each case is small and consistently below \sqrt{n}log(n) when n gets large, implying that the number of measurements for a fixed precision scales better than this.

FIG. 6 depicts an example classical/quantum computer 600 for performing some or all of the classical and quantum operations described in this specification. The example classical/quantum computer 600 includes an example quantum computing device 602. The quantum computing device 602 is intended to represent various forms of quantum computing devices. The components shown here, their connections and relationships, and their functions, are exemplary only, and do not limit implementations of the inventions described and/or claimed in this document.

The example quantum computing device 602 includes a qubit assembly 652 and a control and measurement system 604. The qubit assembly includes multiple qubits, e.g., qubit 606, that are used to perform algorithmic operations or quantum computations. While the qubits shown in FIG. 6 are arranged in a rectangular array, this is a schematic depiction and is not intended to be limiting. The qubits can also be arrange in other forms, e.g., in a line. The qubit assembly 652 also includes adjustable coupling elements, e.g., coupler 608, that allow for interactions between coupled qubits. In the schematic depiction of FIG. 6, each qubit is adjustably coupled to each of its four adjacent qubits by means of respective coupling elements. However, this is an example arrangement of qubits and couplers and other arrangements are possible, including arrangements that are non-rectangular, arrangements that allow for coupling between non-adjacent qubits, and arrangements that include adjustable coupling between more than two qubits.

Each qubit can be a physical two-level quantum system or device having levels representing logical values of 0 and 1. The specific physical realization of the multiple qubits and how they interact with one another is dependent on a variety of factors including the type of the quantum computing device 602 included in the example computer 600 or the type of quantum computations that the quantum computing device is performing. For example, in an atomic quantum computer the qubits may be realized via atomic, molecular or solid-state quantum systems, e.g., hyperfine atomic states. As another example, in a superconducting quantum computer the qubits may be realized via superconducting qubits or semi-conducting qubits, e.g., superconducting transmon states. As another example, in a NMR quantum computer the qubits may be realized via nuclear spin states.

In some implementations a quantum computation can proceed by loading qubits, e.g., from a quantum memory, and applying a sequence of unitary operators to the qubits. Applying a unitary operator to the qubits can include applying a corresponding sequence of quantum logic gates to the qubits, e.g., to implement a quantum algorithm such as a quantum principle component algorithm. Example quantum logic gates include single-qubit gates, e.g., Pauli-X, Pauli-Y, Pauli-Z (also referred to as X, Y, Z), Hadamard gates, S gates, rotations, two-qubit gates, e.g., controlled-X, controlled-Y, controlled-Z (also referred to as CX, CY, CZ), controlled NOT gates (also referred to as CNOT) controlled swap gates (also referred to as CSWAP), and gates involving three or more qubits, e.g., Toffoli gates. The quantum logic gates can be implemented by applying control signals 610 generated by the control and measurement system 604 to the qubits and to the couplers.

For example, in some implementations the qubits in the qubit assembly 652 can be frequency tunable. In these examples, each qubit can have associated operating frequencies that can be adjusted through application of voltage pulses via one or more drive-lines coupled to the qubit. Example operating frequencies include qubit idling frequencies, qubit interaction frequencies, and qubit readout frequencies. Different frequencies correspond to different operations that the qubit can perform. For example, setting the operating frequency to a corresponding idling frequency may put the qubit into a state where it does not strongly interact with other qubits, and where it may be used to perform single-qubit gates. As another example, in cases where qubits interact via couplers with fixed coupling, qubits can be configured to interact with one another by setting their respective operating frequencies at some gate-dependent frequency detuning from their common interaction frequency. In other cases, e.g., when the qubits interact via tunable couplers, qubits can be configured to interact with one another by setting the parameters of their respective couplers to enable interactions between the qubits and then by setting the qubit's respective operating frequencies at some gate-dependent frequency detuning from their common interaction frequency. Such interactions may be performed in order to perform multi-qubit gates.

The type of control signals 610 used depends on the physical realizations of the qubits. For example, the control signals may include RF or microwave pulses in an NMR or superconducting quantum computer system, or optical pulses in an atomic quantum computer system.

A quantum computation can be completed by measuring the states of the qubits, e.g., using a quantum observable such as X or Z, using respective control signals 610. The measurements cause readout signals 612 representing measurement results to be communicated back to the measurement and control system 604. The readout signals 612 may include RF, microwave, or optical signals depending on the physical scheme for the quantum computing device and/or the qubits. For convenience, the control signals 610 and readout signals 612 shown in FIG. 6 are depicted as addressing only selected elements of the qubit assembly (i.e. the top and bottom rows), but during operation the control signals 610 and readout signals 612 can address each element in the qubit assembly 652.

The control and measurement system 604 is an example of a classical computer system that can be used to perform various operations on the qubit assembly 652, as described above, as well as other classical subroutines or computations. The control and measurement system 604 includes one or more classical processors, e.g., classical processor 614, one or more memories, e.g., memory 616, and one or more I/O units, e.g., I/O unit 618, connected by one or more data buses. The control and measurement system 604 can be programmed to send sequences of control signals 610 to the qubit assembly, e.g. to carry out a selected series of quantum gate operations, and to receive sequences of readout signals 612 from the qubit assembly, e.g. as part of performing measurement operations.

The processor 614 is configured to process instructions for execution within the control and measurement system 604. In some implementations, the processor 614 is a single-threaded processor. In other implementations, the processor 614 is a multi-threaded processor. The processor 614 is capable of processing instructions stored in the memory 616.

The memory 616 stores information within the control and measurement system 604. In some implementations, the memory 616 includes a computer-readable medium, a volatile memory unit, and/or a non-volatile memory unit. In some cases, the memory 616 can include storage devices capable of providing mass storage for the system 604, e.g. a hard disk device, an optical disk device, a storage device that is shared over a network by multiple computing devices (e.g., a cloud storage device), and/or some other large capacity storage device.

The input/output device 618 provides input/output operations for the control and measurement system 604. The input/output device 618 can include D/A converters, A/D converters, and RF/microwave/optical signal generators, transmitters, and receivers, whereby to send control signals 610 to and receive readout signals 612 from the qubit assembly, as appropriate for the physical scheme for the quantum computer. In some implementations, the input/output device 618 can also include one or more network interface devices, e.g., an Ethernet card, a serial communication device, e.g., an RS-232 port, and/or a wireless interface device, e.g., an 802.11 card. In some implementations, the input/output device 618 can include driver devices configured to receive input data and send output data to other external devices, e.g., keyboard, printer and display devices.

Although an example control and measurement system 604 has been depicted in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

The example system 600 also includes an example classical processor 650. The classical processor 650 can be used to perform classical computation operations described in this specification according to some implementations.

Implementations of the subject matter and operations described in this specification can be implemented in digital electronic circuitry, analog electronic circuitry, suitable quantum circuitry or, more generally, quantum computational systems, in tangibly-embodied software or firmware, in computer hardware, including the structures disclosed in this specification and their structural equivalents, or in combinations of one or more of them. The term “quantum computational systems” may include, but is not limited to, quantum computers, quantum information processing systems, quantum cryptography systems, or quantum simulators.

Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, one or more qubits, or a combination of one or more of them. Alternatively or in addition, the program instructions can be encoded on an artificially-generated propagated signal that is capable of encoding digital and/or quantum information, e.g., a machine-generated electrical, optical, or electromagnetic signal, that is generated to encode digital and/or quantum information for transmission to suitable receiver apparatus for execution by a data processing apparatus.

The terms quantum information and quantum data refer to information or data that is carried by, held or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, multiple digital and quantum processors or computers, and combinations thereof. The apparatus can also be, or further include, special purpose logic circuitry, e.g., an FPGA (field programmable gate array), an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL or Quipper.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable computers, operating with one or more processors, as appropriate, executing one or more computer programs to perform functions by operating on input data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more computers to be “configured to” perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For example, a quantum computer may receive instructions from a digital computer that, when executed by the quantum computing apparatus, cause the apparatus to perform the operations or actions.

Computers suitable for the execution of a computer program can be based on general or special purpose processors, or any other kind of central processing unit. Generally, a central processing unit will receive instructions and data from a read-only memory, a random access memory, or quantum systems suitable for transmitting quantum data, e.g. photons, or combinations thereof.

The elements of a computer include a central processing unit for performing or executing instructions and one or more memory devices for storing instructions and digital, analog, and/or quantum data. The central processing unit and the memory can be supplemented by, or incorporated in, special purpose logic circuitry or quantum simulators. Generally, a computer will also include, or be operatively coupled to receive data from or transfer data to, or both, one or more mass storage devices for storing data, e.g., magnetic, magneto-optical disks, optical disks, or quantum systems suitable for storing quantum information. However, a computer need not have such devices.

Quantum circuit elements (also referred to as quantum computing circuit elements) include circuit elements for performing quantum processing operations. That is, the quantum circuit elements are configured to make use of quantum-mechanical phenomena, such as superposition and entanglement, to perform operations on data in a non-deterministic manner. Certain quantum circuit elements, such as qubits, can be configured to represent and operate on information in more than one state simultaneously. Examples of superconducting quantum circuit elements include circuit elements such as quantum LC oscillators, qubits (e.g., flux qubits, phase qubits, or charge qubits), and superconducting quantum interference devices (SQUIDs) (e.g., RF-SQUID or DC-SQUID), among others.

In contrast, classical circuit elements generally process data in a deterministic manner. Classical circuit elements can be configured to collectively carry out instructions of a computer program by performing basic arithmetical, logical, and/or input/output operations on data, in which the data is represented in analog or digital form. In some implementations, classical circuit elements can be used to transmit data to and/or receive data from the quantum circuit elements through electrical or electromagnetic connections. Examples of classical circuit elements include circuit elements based on CMOS circuitry, rapid single flux quantum (RSFQ) devices, reciprocal quantum logic (RQL) devices and ERSFQ devices, which are an energy-efficient version of RSFQ that does not use bias resistors.

In certain cases, some or all of the quantum and/or classical circuit elements may be implemented using, e.g., superconducting quantum and/or classical circuit elements. Fabrication of the superconducting circuit elements can entail the deposition of one or more materials, such as superconductors, dielectrics and/or metals. Depending on the selected material, these materials can be deposited using deposition processes such as chemical vapor deposition, physical vapor deposition (e.g., evaporation or sputtering), or epitaxial techniques, among other deposition processes. Processes for fabricating circuit elements described herein can entail the removal of one or more materials from a device during fabrication. Depending on the material to be removed, the removal process can include, e.g., wet etching techniques, dry etching techniques, or lift-off processes. The materials forming the circuit elements described herein can be patterned using known lithographic techniques (e.g., photolithography or e-beam lithography).

During operation of a quantum computational system that uses superconducting quantum circuit elements and/or superconducting classical circuit elements, such as the circuit elements described herein, the superconducting circuit elements are cooled down within a cryostat to temperatures that allow a superconductor material to exhibit superconducting properties. A superconductor (alternatively superconducting) material can be understood as material that exhibits superconducting properties at or below a superconducting critical temperature. Examples of superconducting material include aluminum (superconductive critical temperature of 1.2 kelvin) and niobium (superconducting critical temperature of 9.3 kelvin). Accordingly, superconducting structures, such as superconducting traces and superconducting ground planes, are formed from material that exhibits superconducting properties at or below a superconducting critical temperature.

In certain implementations, control signals for the quantum circuit elements (e.g., qubits and qubit couplers) may be provided using classical circuit elements that are electrically and/or electromagnetically coupled to the quantum circuit elements. The control signals may be provided in digital and/or analog form.

Computer-readable media suitable for storing computer program instructions and data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or system that may include one or more processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for computing a classical shadow of an n-qubit quantum state, the method comprising:
repeatedly sampling, by a classical computer, a unitary operator from an ensemble of random unitaries, wherein the ensemble of random unitaries comprises a generalized matchgate group;
for each sampled unitary operator:
applying, by a quantum computer, a quantum circuit to the n-qubit quantum state to obtain an evolved quantum state, wherein the quantum circuit implements the sampled unitary operator,
measuring, by the quantum computer, the evolved quantum state to obtain a respective bit string, and
storing, by the classical computer, a record of the respective bit string and the sampled unitary operator; and
providing, by the classical computer, the records as a classical shadow of the quantum state.

2. The method of claim 1, wherein generators of the generalized matchgate group comprise:
unitary operators that are generated by an action of operators XⱼXⱼ₊₁, XⱼYⱼ₊₁, YⱼXⱼ₊₁ or YⱼYⱼ₊₁ on an array of n qubits, where 1≤j≤n, Xⱼ represents a Pauli-X operator applied to qubit j, and Yⱼ represents a Pauli-Y operator applied to qubit j; and
unitary operators that are generated by an action of Pauli-X operators on qubit n.

3. The method of claim 1, wherein
the generalized matchgate group has a one-to-one correspondence with a group of 2n×2n orthogonal matrices O(2n); and
for every element R in the group O(2n) there exists a unique unitary operator in the generalized matchgate group that satisfies UγⱼU^{†}=Σ_{j∈[1 . ..2n]}Rₖⱼγₖ.

4. The method of claim 3, wherein sampling the unitary operator from the ensemble of random unitaries comprises sampling from the group O(2n) according to a Haar measure and constructing a corresponding generalized matchgate unitary operator using the one-to-one correspondence.

5. The method of claim 1, wherein the classical shadow is given by
$$\hat{ρ} = \frac{1}{J} {\sum }_{j = 1}^{J} {\sum }_{l = 0}^{n} ( \begin{matrix}2 n \\ 2 l\end{matrix} ) {( \begin{matrix}n \\ l\end{matrix} )}^{- 1} {𝒫}_{2 l} ( {U}_{j}^{†} \vert {b}_{j} 〉 〈 {b}_{j} \vert {U}_{j} )$$
where J represents a number of repetitions performed to sample the unitary operators, Uⱼ represents the unitary operator sampled at repetition j, bⱼ represents the bit string stored at repetition j, and [symbol] ₂ₗ represents a super-operator that projects an input onto a set of Majorana operators with degree 2l.

6. The method of claim 1, further comprising performing one or more operations using the classical shadow of the quantum state, the operations comprising one or more of:
predicting an expectation value of an observable with respect to the quantum state, performing direct fidelity estimation, performing entanglement verification, estimating correlation functions, or predicting entanglement entropy.

7. A system comprising:
a quantum computer; and
a classical computer coupled to the quantum computer, the classical computer comprising:
one or more data processing apparatuses; and
non-transitory computer readable storage media in data communication with the one or more data processing apparatuses and storing instructions executable by the data processing apparatuses;
wherein the system is configured to perform operations for computing a classical shadow of an n-qubit quantum state, the operations comprising:
repeatedly sampling, by a classical computer, a unitary operator from an ensemble of random unitaries, wherein the ensemble of random unitaries comprises a generalized matchgate group;
for each sampled unitary operator:
applying, by a quantum computer, a quantum circuit to the n-qubit quantum state to obtain an evolved quantum state, wherein the quantum circuit implements the sampled unitary operator,
measuring, by the quantum computer, the evolved quantum state to obtain a respective bit string, and
storing, by the classical computer, a record of the respective bit string and the sampled unitary operator; and
providing, by the classical computer, the records as a classical shadow of the quantum state.

8. The system of claim 7, wherein the quantum computer comprises a noisy quantum computing device, a superconducting quantum computer, or an analog simulator based on neutral atoms or ion traps.

9. The system of claim 7, wherein generators of the generalized matchgate group comprise:
unitary operators that are generated by an action of operators XⱼXⱼ₊₁, XⱼYⱼ₊₁, YⱼXⱼ₊₁ or YⱼYⱼ₊₁ on an array of n qubits, where 1≤j≤n, Xⱼ represents a Pauli-X operator applied to qubit j, and Yⱼ represents a Pauli-Y operator applied to qubit j; and
unitary operators that are generated by an action of Pauli-X operators on qubit n.

10. The system of claim 7, wherein
the generalized matchgate group has a one-to-one correspondence with a group of 2n×2n orthogonal matrices O(2n); and
for every element R in the group O(2n) there exists a unique unitary operator in the generalized matchgate group that satisfies UγⱼU^{†}=Σ_{j∈[1 . ..2n]}Rₖⱼγₖ.

11. The system of claim 10, wherein sampling the unitary operator from the ensemble of random unitaries comprises sampling from the group O(2n) according to a Haar measure and constructing a corresponding generalized matchgate unitary operator using the one-to-one correspondence.

12. The system of claim 7, wherein the classical shadow is given by
$$\hat{ρ} = \frac{1}{J} {\sum }_{j = 1}^{J} {\sum }_{l = 0}^{n} ( \begin{matrix}2 n \\ 2 l\end{matrix} ) {( \begin{matrix}n \\ l\end{matrix} )}^{- 1} {𝒫}_{2 l} ( {U}_{j}^{†} \vert {b}_{j} 〉 〈 {b}_{j} \vert {U}_{j} )$$
where J represents a number of repetitions performed to sample the unitary operators, Uⱼ represents the unitary operator sampled at repetition j, bⱼ represents the bit string stored at repetition j, and [symbol] ₂ₗ represents a super-operator that projects an input onto a set of Majorana operators with degree 2l.

13. The system of claim 7, wherein the operations further comprise performing one or more computing operations using the classical shadow of the quantum state, the one or more computing operations comprising one or more of: predicting an expectation value of an observable with respect to the quantum state, performing direct fidelity estimation, performing entanglement verification, estimating correlation functions, or predicting entanglement entropy.

14. A computer implemented method for computing an expectation value of a projector operator, the method comprising:
obtaining a classical shadow of an n-qubit quantum state, wherein the classical shadow comprises a quantum channel of unitary operators sampled from an ensemble of random unitaries and measured bit strings;
generating updated unitary operators, comprising multiplying a unitary operator that defines the projector operator with i) the unitary operators sampled from the ensemble of random unitaries and ii) operators that prepare the measured bit strings from a vacuum state; and
computing the expectation value of the quantum channel with respect to the vacuum state, the computing comprising evaluating derivatives of a polynomial, the polynomial comprising a Pfaffian of a matrix comprising the updated unitary operators.

15. The method of claim 14, wherein the projection operator comprises an operator that projects a quantum state onto a pure fermionic Gaussian state, wherein the pure fermionic Gaussian state comprises a unitary operator in the ensemble of random unitaries applied to a vacuum state, wherein the projector operator is given by |ϕ [symbol] [symbol] |=Ũ|0 [symbol] [symbol] 0|Ũ^{†} where |0 [symbol] represents the vacuum state and Ũ is the unitary operator that defines the projector operator, wherein Ũ is in the ensemble of random unitaries.

16. The method of claim 14, wherein the ensemble of random unitaries comprises a generalized matchgate group.

17. The method of claim 16, wherein the classical shadow is given by
$$\hat{ρ} = \frac{1}{J} {\sum }_{j = 1}^{J} {\sum }_{l = 0}^{n} ( \begin{matrix}2 n \\ 2 l\end{matrix} ) {( \begin{matrix}n \\ l\end{matrix} )}^{- 1} {𝒫}_{2 l} ( {U}_{j}^{†} \vert {b}_{j} 〉 〈 {b}_{j} \vert {U}_{j} )$$
where J represents a number of repetitions performed to sample the unitary operators, Uⱼ represents the unitary operator sampled at repetition j, bⱼ represents the bit string stored at repetition j, and [symbol] ₂ₗ represents a super-operator that projects an input onto a set of Majorana operators with degree 2l, wherein [symbol] ₂ₗ is equivalent to the quantum channel.

18. The method of claim 17, wherein generating the updated unitary operators comprises redefining the unitary operators Uⱼ to absorb the unitary operator Ũ and the preparation of |bⱼ [symbol] from |0 [symbol] , wherein computing the expectation value of the quantum channel with respect to the vacuum state comprises computing the expectation value of the super-operator with respect to the vacuum state, wherein the super-operator projects the updated unitary operators applied to the vacuum state onto a set of Majorana operators with degree 2l, wherein computing the expectation value of the super-operator with respect to the vacuum state comprises computing tr[|0 [symbol] [symbol] 0| [symbol] ₂ₗ(U^{†}|0 [symbol] [symbol] 0|U)].

19. The method of claim 14, wherein the matrix that comprises the updated unitary operators is given by
$${M}_{0} + z Q {M}_{0} {Q}^{T} where {M}_{0} = {[ \begin{matrix}0 & 1 \\ - 1 & 0\end{matrix} ]}^{⊗ n} ,$$
z is the argument of the polynomial, and Q represents an element of SO(2n) that corresponds to the updated unitary operator.

20. The method of claim 14, wherein evaluating the derivatives of the polynomial comprises performing numerical differentiation or polynomial interpolation techniques.
